(19) United States
(12) Patent Application Publication
(10) Pub. No.: US 2015/0293735 A1
(43) Pub. Date: Oct. 15, 2015

(54) COMMUNICATION METHOD, COMMUNICATION TERMINAL, AND STORAGE MEDIUM

(71) Applicant: CANON KABUSHIKI KAISHA, Tokyo (JP)

(72) Inventor: Ryoya Kawai, Kawasaki-shi (JP)

(21) Appl. No.: 14/677,522

(22) Filed: Apr. 2, 2015

(30) Foreign Application Priority Data
Apr. 9, 2014 (JP) 2014-080496

(51) Int. Cl. G06F 3/12

(52) U.S. Cl. CPC G06F 3/1292; G06F 3/1236

(57) ABSTRACT

An embodiment of this invention is directed to a technique in which in a case where a mobile terminal and an MFP are directly connected to each other, the mobile terminal can readily obtain print data existing in a Web server apparatus and transmit the print data to the MFP. According to the embodiment, for example, connection information to the MFP is obtained from the MFP by using a short distance wireless communication method such as NFC. The print data existing in the Web server apparatus is obtained via a network. Furthermore, communication with the MFP is established using a wireless communication method such as a WLAN different from the short distance wireless communication method. The obtained print data is transmitted to the MFP. After that, the established communication is released.

### BACKGROUND OF THE INVENTION

1. Field of the Invention

The present invention relates to a communication method, a communication terminal, and a storage medium, and particularly to a communication method using short distance wireless communication, a communication terminal, and a storage medium.

2. Description of the Related Art

There is conventionally provided a method of transmitting, to another information processing apparatus, data existing in a Web server apparatus capable of being browsed using a mobile terminal in order to cause the other information processing apparatus to process the data (see Japanese Patent Laid-Open No. 2013-184297). According to Japanese Patent Laid-Open No. 2013-184297, when a mobile terminal performs authentication with an information processing apparatus via a communication interface for communication establishment, establishes communication to be desirably connected, and issues a data request to the information processing apparatus, a Web server apparatus transmits data to the information processing apparatus in response to the request.

The method described in Japanese Patent Laid-Open No. 2013-184297 assumes that the information processing apparatus can communicate with the Web server apparatus via a network. However, the user may use the mobile terminal and the information processing apparatus by directly connecting them without intervention of an external access point between the mobile terminal and the information processing apparatus.

In this case, the information processing apparatus may be unable to communicate with the Web server apparatus, and thus may be unable to obtain data on the Web server apparatus.

In this case, the user temporarily releases the connection between the mobile terminal and the information processing apparatus by a manual operation, and obtains the data saved in the Web server apparatus using the mobile terminal. After completion of obtaining the data, the user needs to reconnect the mobile terminal and the information processing apparatus by a manual operation.

### SUMMARY OF THE INVENTION

Accordingly, the present invention is conceived as a response to the above-described disadvantages of the conventional art.

For example, a communication method, a communication terminal, and a storage medium according to this invention are capable of causing the communication terminal to readily obtain data from a Web server apparatus and transmit the data to an information processing apparatus.

According to one aspect of the present invention, there is provided a communication method for a communication terminal which communicates with an information processing apparatus, comprising: obtaining, by using a first communication method by short distance wireless communication, from the information processing apparatus, connection information for communication with the information processing apparatus by a second communication method; obtaining data existing in an external apparatus via a network; establishing communication with the information processing apparatus by the second communication method by using the obtained connection information after the data is obtained; and transmitting the obtained data to the information processing apparatus by the established communication.

The invention is particularly advantageous since communication with an information processing apparatus is established by a predetermined communication method after data existing in a Web server apparatus is obtained via a network. Consequently, it is possible to readily obtain data from the Web server apparatus, and transmit the data to the information processing apparatus.

Further features of the present invention will become apparent from the following description of exemplary embodiments (with reference to the attached drawings).

### BRIEF DESCRIPTION OF THE DRAWINGS

FIG. 1 is a block diagram showing the overall configuration of a network system capable of performing communication by short distance wireless communication according to an embodiment of the present invention.

FIG. 2 is a front view showing a mobile terminal.

FIGS. 3A and 3B are a perspective view and a plan view, respectively, showing the outer appearance of an MFP.

FIG. 4 is a block diagram showing the arrangement of the mobile terminal.

FIG. 5 is a block diagram showing the schematic arrangement of the MFP.

FIG. 6 is a view showing a case in which thumbnails of print candidates are displayed on the mobile terminal.

FIG. 7 is a flowchart illustrating print data obtaining processing executed by a mobile terminal according to the first embodiment.

FIG. 8 is a flowchart illustrating print data obtaining processing executed by a mobile terminal according to the third embodiment.

### DESCRIPTION OF THE EMBODIMENTS

Exemplary embodiments of the present invention will now be described in detail in accordance with the accompanying drawings. Note that the relative arrangement of components and the like set forth in the embodiments do not limit the scope of the present invention unless otherwise specified.

In this specification, the terms “print” and “printing” not only include the formation of significant information such as characters and graphics, but also broadly includes the formation of images, figures, patterns, and the like on a print medium, or the processing of the medium, regardless of whether they are significant or insignificant and whether they are so visualized as to be visually perceivable by humans.

Also, the term “print medium” not only includes a paper sheet used in common printing apparatuses, but also broadly includes materials, such as cloth, a plastic film, a metal plate, glass, ceramics, wood, and leather, capable of accepting ink.

In this embodiment, in communication between a mobile terminal and a multi-function printer (to be referred to as an MFP hereinafter), authentication and the like are performed by low-speed communication (first communication method) using a short distance wireless communication method, and the communication method is switched over to high-speed communication (second communication method) of wireless communication to transmit data. More specifically, authentication is performed by NFC (Near Field Communication), and wireless communication of another communication method takes over the communication.

FIG. 1 is a block diagram showing the configuration of a communication system (to be referred to as a system hereinafter) using wireless communication according to an exemplary embodiment of the present invention.

In this system, a Web server apparatus 101 and a mobile communication terminal apparatus (to be referred to as a mobile terminal hereinafter) 200 are connected via a network 100 including an LAN and the Internet. On the other hand, the mobile terminal 200 and a multi-function printer (to be referred to as an MFP hereinafter) 300 as an embodiment of an information processing apparatus are directly connected to each other by wireless communication.

The Web server apparatus 101 includes a storage unit for print data and a management unit for Web pages for screen display. Note that the Web server apparatus 101 may be formed from one server apparatus, or a server system formed from a plurality of server apparatuses may operate as the Web server apparatus 101 according to this embodiment.

The mobile terminal 200 is an apparatus integrating at least two types of wireless communication protocols with different authentication methods and different communication speeds. The mobile terminal can be any type of an apparatus capable of handling files to undergo predetermined processing, for example, a personal information terminal such as a PDA (Personal Digital Assistant), a mobile phone, a digital camera, or a smartphone. In this embodiment, a mobile communication terminal will be mainly exemplified. However, the communication terminal is not limited to this. Note that the predetermined processing is, for example, printing executed by the MFP 300.

The MFP 300 is a multi-function printer apparatus including a display unit and operation panel through which various settings can be made, and having a printer function of using an inkjet printer or the like as a printer engine, a scanner function of reading a document placed on a document table, a FAX function, and a telephone function.

The network 100 and Web server apparatus 101 are connected via a wired LAN or wireless LAN (to be referred to as a WLAN hereinafter). The network 100 and mobile terminal 200 are connected via a WLAN or wireless telephone line. The mobile terminal 200 and MFP 300 are connected using the access point function of the MFP 300.

This embodiment will be described below by using a case in which the MFP 300 prints an image based on received print data.

Upon receiving a request to obtain information of the access point function from the mobile terminal 200 by using NFC, the MFP 300 transmits the information to the mobile terminal 200. The information of the access point function includes an SSID and password for performing connection to the MFP 300. The mobile terminal 200 holds the information of the access point function transmitted from the MFP 300. Note that when the information of the access point function is requested, the MFP 300 enters a standby state to perform connection to the mobile terminal 200 using the access point function.

After that, the mobile terminal 200 receives print data from the Web server apparatus 101. Upon completion of the reception processing, the mobile terminal 200 is connected to the MFP 300 using the access point function of the MFP 300 which is in the standby state. After establishment of connection, the mobile terminal 200 transmits the print data to the MFP 300 via the established connection, and the MFP 300 prints an image based on the received print data. As described above, the mobile terminal 200 automatically switches over the connection to the MFP 300 after receiving the print data from the Web server apparatus 101. Therefore, even if the print data is in the Web server apparatus 101, printing can be executed.

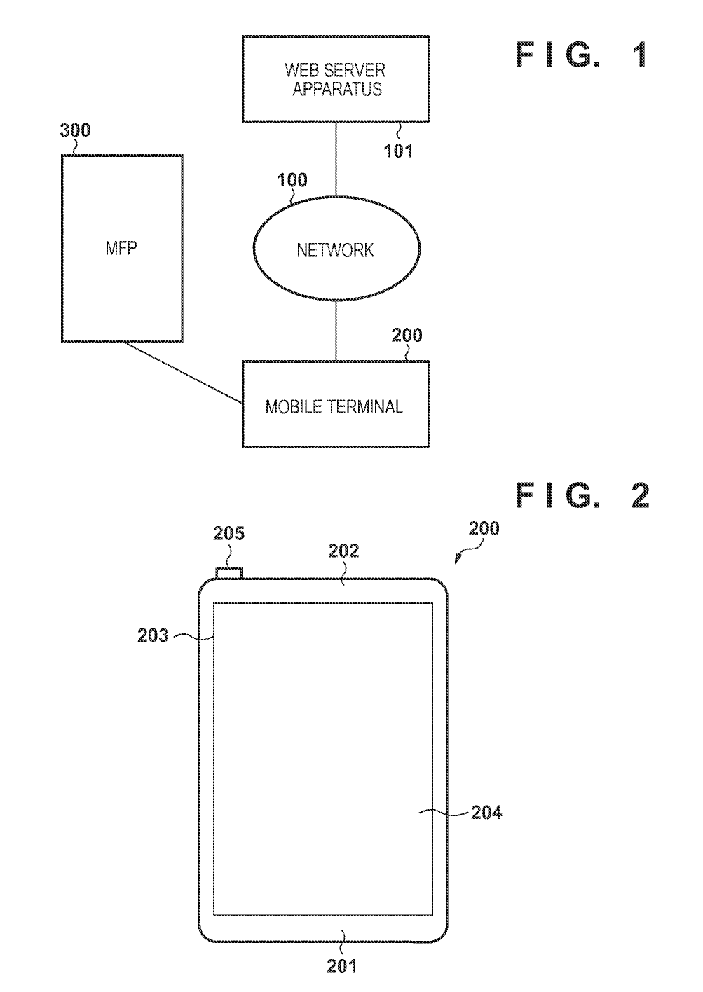

FIG. 2 is a front view showing the mobile terminal 200 such as a smartphone. The smartphone indicates a multi-function mobile phone including a camera, network browser, and mail function in addition to a mobile phone function.

Referring to FIG. 2, an NFC unit 201 performs communication using NFC. Communication can be performed when the user actually moves the NFC unit 201 close to within about 10 cm of the NFC unit of a communication party. A WLAN unit 202 is used to perform communication using a WLAN, and arranged within the apparatus. Note that the communicable range of a WLAN is wider than that (about 10 cm) of NFC. If the distance between communication apparatuses is longer than the communicable range of NFC, WLAN communication is possible. The mobile terminal 200 performs NFC communication with the MFP 300 to obtain/save information about the access point function. After receiving print data necessary for printing from the Web server apparatus 101, the mobile terminal 200 performs WLAN communication with the MFP 300. Therefore, after obtaining/saving the information about the access point function by NFC, even if the distance between the mobile terminal 200 and the MFP 300 is longer than the communicable range (about 10 cm) of NFC, communication is possible.

A display unit 203 is formed from an LCD display on which an operation unit 204 with an electrostatic touch-panel operation mechanism is arranged. The operation unit 204 detects user operation information. As a typical operation method, the display unit 203 displays button-shaped menus, and when the user touches the operation unit 204, an event associated with the button portion is issued to execute processing. A power key 205 is used to turn on/off the power.

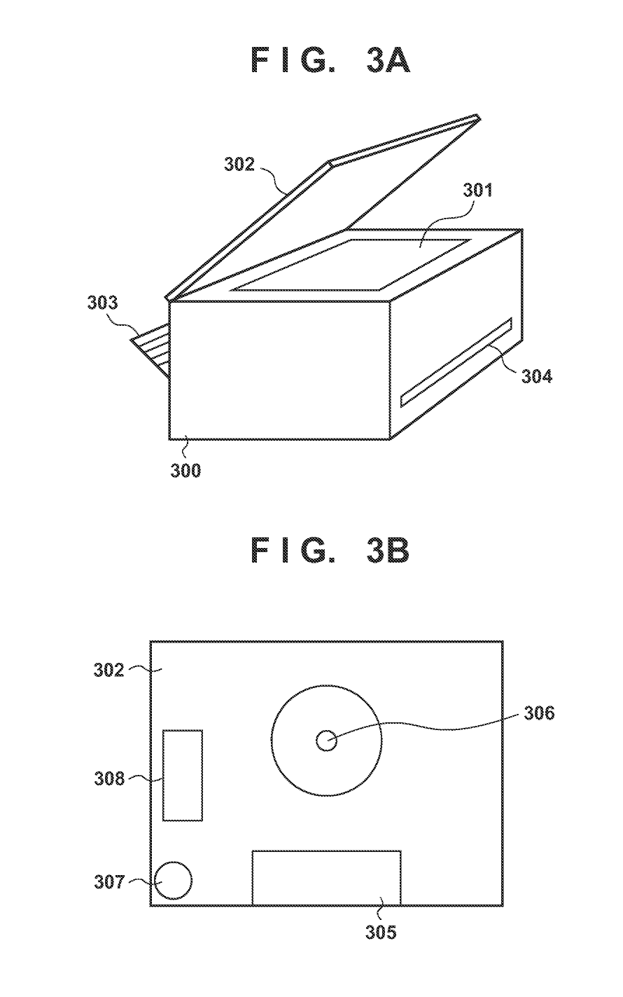

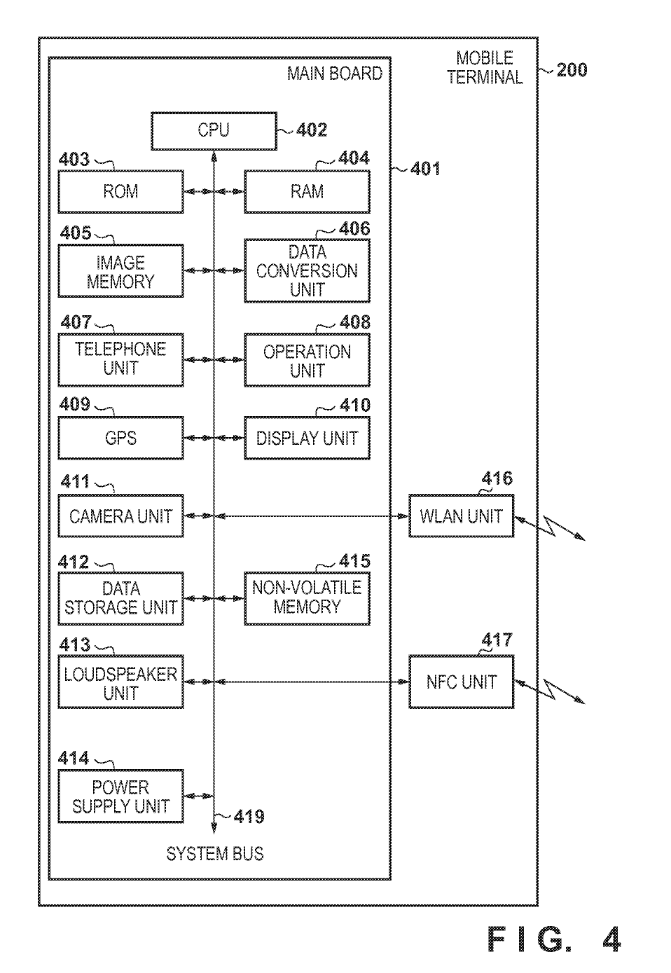

FIGS. 3A and 3B are views each schematically showing the outer appearance of the MFP 300. FIG. 3A is a perspective view showing the outer appearance and FIG. 3B is a plan view showing the MFP.

A document table 301 is a transparent glass table and is used to place a document to be read by the scanner. A document cover 302 is used to prevent reading light from externally leaking at the time of reading by the scanner. A printing paper insertion port 303 is used to set paper sheets of various sizes. The paper sheets set in the printing paper insertion port 303 are conveyed to a printing unit (printer engine) one by one, undergo desired printing, and are discharged from a printing paper discharge port 304.

As shown in FIG. 3B, an operation display unit 305 and an NFC unit 306 are arranged on the document cover 302. The operation display unit 305 includes keys for various operations and an LCD display, with which it is possible to perform an operation and make settings for the MFP 300. The NFC unit 306 is a unit used to perform short distance wireless communication, and is a place, close to which the user actually moves the mobile terminal 200. An effective communicable range is about 10 cm from the NFC unit 306. A WLAN antenna 307 is an antenna used to perform WLAN communication, and is embedded in the document cover 302. An access point unit 308 is a unit used to connect the mobile terminal 200 to the MFP 300 via a WLAN.

When the access point unit 308 operates in an access point (AP) mode, WLAN connection is established in one-to-one correspondence with the mobile terminal 200, and the mobile terminal 200 may be unable to communicate with another device. For example, the mobile terminal 200 may transmit data obtained from an external apparatus such as a Web server apparatus, another mobile terminal, or external PC to the MFP 300 via a WLAN. In this case, if WLAN connection to the MFP 300 has already been established before the data is obtained, the mobile terminal 200 may be unable to communicate with another apparatus, and thus may be unable to obtain the data, as described above.

To cope with this, in this embodiment, if the mobile terminal 200 obtains data from an external apparatus, and then transmits the data to the MFP 300 via a WLAN, the above obtaining processing is performed in a state in which the mobile terminal 200 stands by for establishment of connection to the MFP 300. Details will be described later.

FIG. 4 is a block diagram showing the arrangement of the mobile terminal 200.

The mobile terminal 200 includes a main board 401 for controlling the overall apparatus, a WLAN unit 416 for performing WLAN communication, and an NFC unit 417 for performing NFC communication.

A CPU 402 of the main board 401 serves as a system control unit for controlling the overall mobile terminal 200. A ROM 403 stores control programs, an embedded operating system (OS) program, and the like to be executed by the CPU 402. In this embodiment, each control program stored in the ROM 403 performs software control such as scheduling or task switching under the management of the embedded OS stored in the ROM 403. A RAM 404 is formed from an SRAM or the like. The RAM 404 stores program control variables, setting values registered by the user, management data for the mobile terminal 200, and the like, and also is used as various work buffer areas.

An image memory 405 is formed from a DRAM or the like, and temporarily stores image data received via a communication unit or image data read out from a data storage unit 412 for processing by the CPU 402. A non-volatile memory 415 is formed from a flash memory or the like, and stores data to be saved even after power-off. Examples of the data are telephone directory data and information of devices connected in the past. Note that the memory structure is not limited to that shown in FIG. 4. For example, the image memory 405 and RAM 404 may share a memory, or data may be backed up in the data storage unit 412. Although the DRAM is used in this embodiment, the present invention is not limited to this, and a hard disk, a non-volatile memory, or the like may be used.

A data conversion unit 406 performs analysis of a page description language (PDL) and the like, and data conversion such as color conversion and image conversion. A telephone unit 407 controls a telephone line, and processes voice data input/output via a loudspeaker unit 413, thereby implementing telephone communication. An operation unit 408 controls a signal generated by the operation unit 204 described with reference to FIG. 2. A GPS (Global Positioning System) 409 obtains the current latitude and longitude. A display unit 410 electronically controls display contents of the display unit 203 described with reference to FIG. 2, and can display various input operations, the operation state and status of the MFP 300, and the like.

A camera unit 411 has a function of electronically recording and encoding an image input via a lens. An image captured by the camera unit 411 is saved in the data storage unit 412. The loudspeaker unit 413 implements a function of inputting or outputting voice for the telephone function, an alarm notification function, and the like. A power supply unit 414 includes a portable battery, and controls the power supply. A power supply state includes a battery-empty state in which the battery has no remaining amount, a power-off state in which the power key 205 is not pressed, an active state (power-on state) in which the apparatus is normally active, and a power-saving state in which the apparatus is active but is in a power-saving mode.

The mobile terminal 200 according to this embodiment incorporates an arrangement for executing at least two types of communication methods as a communication method for performing wireless communication. As a communication method, in this embodiment, the mobile terminal 200 performs data communication with another device such as an MFP by performing wireless communication using a WLAN or NFC. At this time, data is converted into a packet, and the packet is transmitted to another device. To the contrary, the WLAN unit or NFC unit receives a packet from another external device, converts the packet into data, and transmits the converted data to the CPU 402. In this embodiment, NFC is used to send connection information for a handover, transmit a job, and exchange billing information. A WLAN takes over wireless connection from NFC by a handover, thereby transmitting and receiving job data at higher speed than NFC. The WLAN unit 416 and NFC unit 417 are connected by bus cables or the like. The WLAN unit 416 and NFC unit 417 are units used to implement communication conforming to the respective specifications.

The above-described components 403 to 417 are connected to each other via a system bus 419 managed by the CPU 402.

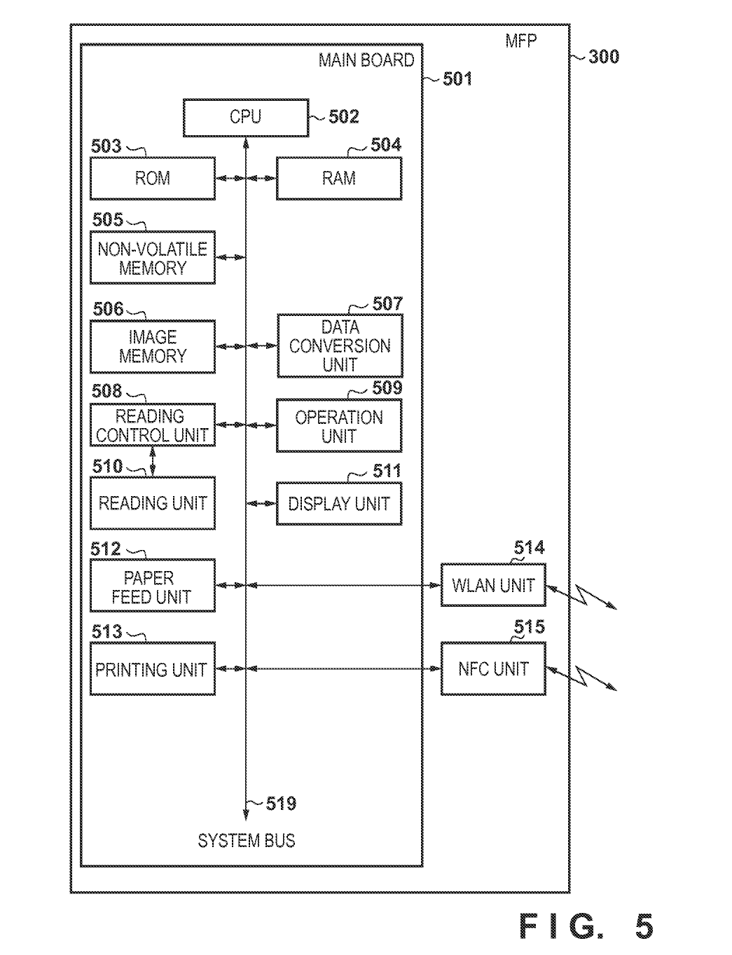

FIG. 5 is a block diagram showing the schematic arrangement of the MFP 300.

The MFP 300 includes a main board 501 for controlling the overall apparatus, a WLAN unit 514 for performing WLAN communication, and an NFC unit 515 for performing NFC communication.

A CPU 502 of the main board 501 serves as a system control unit for controlling the overall MFP 300. A ROM 503 stores control programs, an embedded operating system (OS) program, and the like to be executed by the CPU 502. In this embodiment, each control program stored in the ROM 503 performs software control such as scheduling or task switching under the management of the embedded OS stored in the ROM 503. One of the control programs executes billing control, and exchanges control commands for billing with the mobile terminal 200 using the NFC unit 515.

A RAM 504 is formed from an SRAM or the like. The RAM 504 stores program control variables, setting values registered by the user, management data for the MFP 300, and the like, and also is used as various work buffer areas. A non-volatile memory 505 is formed from a flash memory or the like, and stores data to be held even after power-off. More specifically, the non-volatile memory 505 stores network connection information, user data, and the like. An image memory 506 is formed from a DRAM or the like, and stores image data received via each communication unit, image data processed by a data conversion unit 507, and the like. Like the memory structure of the mobile terminal 200, the memory structure is not limited to this. The data conversion unit 507 performs, for example, analysis of a page description language (PDL) and the like, and conversion of image data into print data.

An image signal generated when a reading unit 510 controlled by a reading control unit 508 causes a CIS image sensor to optically read a document undergoes various image processes such as binarization processing and halftone processing via an image processing control unit (not shown), thereby outputting high-resolution image data.

An operation unit 509 and a display unit 511 represent the operation display unit 305 described with reference to FIG. 3B, and are formed from keys operated by the user, and an LCD for displaying data.

A paper feed unit 512 holds printing media such as printing paper sheets. The paper feed unit 512 can perform a paper feed operation under the control of a printing unit 513. Especially, the paper feed unit may include a plurality of paper feed units to hold a plurality of types of paper sheets in one apparatus. In this case, the printing unit 513 controls to select a paper feed unit to feed paper sheets.

The printing unit 513 converts image data used for printing into high-resolution image data by executing various image processes such as smoothing processing, printing density correction processing, and color correction via the image processing control unit (not shown), and outputs the obtained image data. The printing unit 513 periodically reads out information of the printer engine to update status information stored in the RAM 504. More specifically, the printing unit 513 updates the remaining amount of an ink tank, the state of a printhead, and like.

Similarly to the mobile terminal 200, the MFP 300 uses two wireless communication methods. Each function is the same as that of the mobile terminal 200 and a description thereof will be omitted.

The above-described components 502 to 515 are connected to each other via a system bus 519 managed by the CPU 502.

Some embodiments of printing processing implemented by the network system having the above arrangement will be described.

### First Embodiment

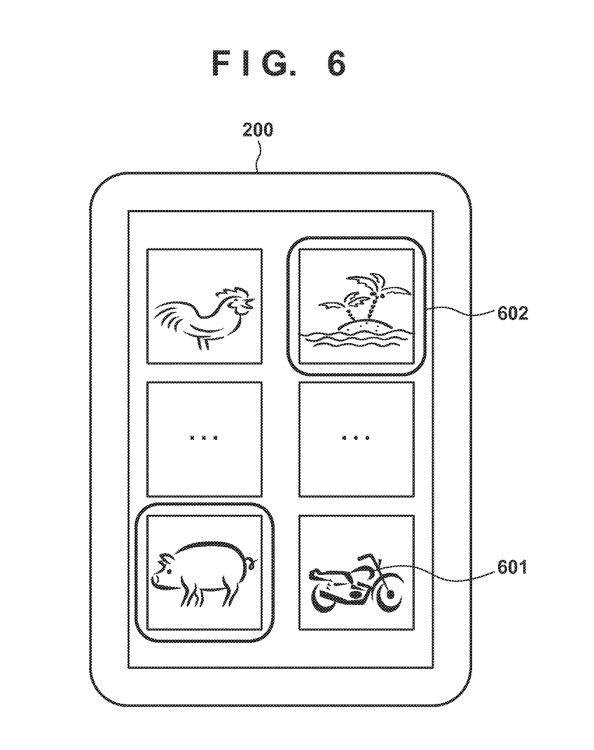

FIG. 6 is a view showing a case in which thumbnails 601 of print candidate images are displayed on a mobile terminal 200.

The thumbnails 601 are those of image data saved in a Web server apparatus 101. When the user presses an image which he/she wishes to print, a focus 602 is displayed to indicate that the image has been set as a print target. The user can select a plurality of images as print targets, and a plurality of focuses 602 may exist on a display portion 203.

A screen shown in FIG. 6 is displayed by, for example, a Web browser stored in a ROM 403 of the mobile terminal 200.

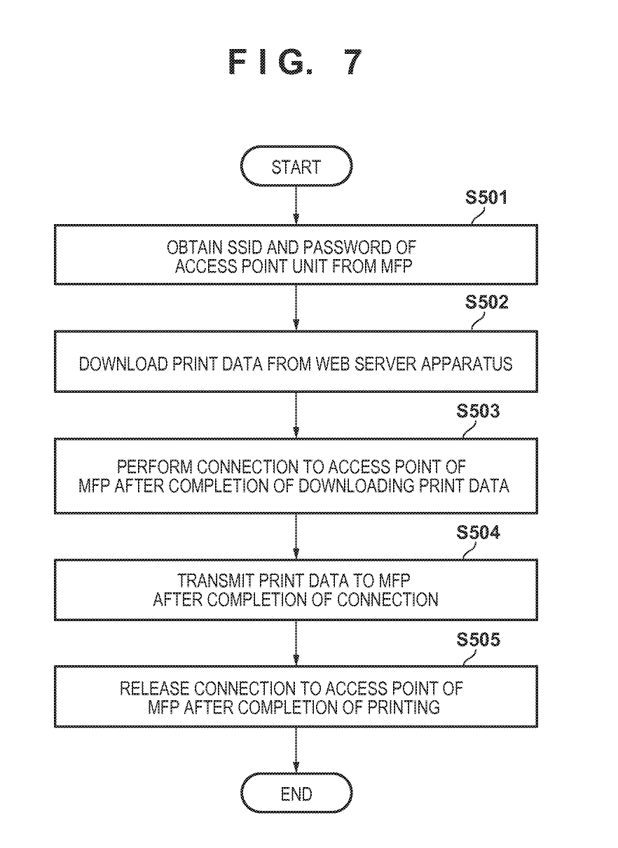

In this embodiment, the mobile terminal 200 obtains an image selected by the user on the screen shown in FIG. 6 from the Web server apparatus 101 via short distance wireless communication between the mobile terminal 200 and an MFP 300, which will be described later with reference to FIG. 7.

That is, even if the user touches a thumbnail on the display screen shown in FIG. 6, an image need not be obtained in response to the touch operation. When the user touches a thumbnail, guidance display such as “please move the mobile terminal close to the NFC unit of the MFP” may be displayed on a display unit 410 of the mobile terminal 200.

Instead of communicating with the MFP 300 using NFC, the user may want to download an image to the mobile terminal 200 and manage the image in the mobile terminal 200. In this case, an option such as “download” may be provided in the above-described guidance display. When the user selects the option on the screen, even if NFC communication is not performed, the mobile terminal 200 may obtain the above image from the Web server apparatus 101.

Note that if thumbnails cannot be displayed within one screen, they may be scrolled and displayed. After selecting an image which the user wishes to print, the user moves an NFC unit 201 of the mobile terminal 200 close to an NFC unit 306 of the MFP 300. This starts communication between the mobile terminal 200 and the MFP 300.

FIG. 7 is a flowchart illustrating print processing according to the first embodiment.

Processing indicated by the flowchart is processing executed by the mobile terminal 200, and is implemented when a CPU 402 executes a program stored in the ROM 403 on a RAM 404. More specifically, for example, after the user selects a thumbnail on the screen shown in FIG. 6, and the above guidance display is displayed, he/she moves the NFC unit 201 of the mobile terminal 200 close to the NFC unit 306 of the MFP 300. After the start of NFC communication between the mobile terminal 200 and the MFP 300, the CPU 402 of the mobile terminal 200 executes the processing shown in FIG. 7.

In step S501, the SSID and password of an access point unit 308 incorporated in the MFP 300 are obtained. Note that in the processing in step S501, communication between the mobile terminal 200 and the MFP 300 is performed using NFC communication.

After the end of the processing, in step S502, the mobile terminal 200 can communicate with the Web server apparatus 101 using a mobile telephone line, and can thus obtain print data existing on the Web server apparatus 101. In a case where, for example, the mobile terminal 200 is connected to an access point such as WiFi, it can communicate with the Web server apparatus 101 using the WiFi-connection, and obtain print data existing on the Web server apparatus 101. This can suppress the communication cost as compared with communication using the mobile telephone line.

Note that in step S502, print data corresponding to a thumbnail selected in advance by the user on the screen shown in FIG. 6 is obtained.

If the SSID and password are not obtained in step S501, it is not necessary to access the Web server apparatus 101 to obtain print data in step S502. This can prevent the mobile terminal 200 from accessing the Web server apparatus 101 in a case where the mobile terminal 200 cannot transmit print data to the MFP via an access point. Alternatively, if the user issues an instruction for obtaining print data even after an error indicating that it is impossible to perform connection to an access point is displayed, print data may be obtained from the Web server apparatus 101.

After the communication processing via the mobile telephone line or access point ends in step S502, the mobile terminal 200 attempts to perform connection to the access point unit 308 of the MFP 300 for the first time in step S503. In step S503, the mobile terminal 200 performs WLAN connection using the SSID and password of the access point unit 308 of the MFP 300 which have been obtained in step S501.

That is, upon completion of the communication processing in step S502, communication with the access point unit 308 of the MFP 300 starts in step S503.

Instead of the above-described processing sequence, for example, consider a case in which the mobile terminal 200 first establishes connection to the access point unit 308 of the MFP 300 (step S503), and then accesses the Web server apparatus 101 via the access point (step S502). In this case, since the mobile terminal 200 has already established connection to the access point of the MFP 300, it may be unable to perform connection to the Web server apparatus 101 via another access point.

In this case, the mobile terminal 200 may have to access the Web server apparatus 101 via the mobile telephone line. Alternatively, although the mobile terminal 200 has not transmitted print data to the MFP 300 yet, it may need to temporarily disconnect the connection to the access point of the MFP 300 by a user operation. The mobile terminal 200 also needs to perform connection to another access point to access the Web server apparatus 101, obtain print data, and then perform reconnection to the access point of the MFP 300.

To cope with this, in this embodiment, since the processes in steps S502 and S503 are performed in the order named, the mobile terminal 200 can appropriately obtain print data from the Web server apparatus 101 via the access point. Since the mobile terminal 200 is connected to the access point of the MFP 300 after obtaining the print data, it need not perform disconnection of the connection to the access point or reconnection to the access point.

The subsequent processing is performed via a WLAN which allows communication at higher speed than NFC and communication outside the effective range of NFC. This is effective at transmitting a relatively large amount of data such as print data. Also, it is not necessary to keep the NFC unit 201 of the mobile terminal 200 close to the NFC unit 306 of the MFP 300 while print data is transmitted, thereby reducing the user's labor.

Upon establishment of communication between the mobile terminal 200 and the MFP 300 via a WLAN in step S503, the process advances to step S504. In step S504, the print data obtained from the Web server apparatus 101 in step S502 is transmitted to the MFP 300. The MFP 300 prints an image based on the received print data. After completion of the print processing, the process advances to step S505, and the mobile terminal 200 releases the connection to the access point unit 308 of the MFP 300. This can reduce, as much as possible, a state in which the mobile terminal 200 cannot be connected to the Internet.

According to the above-described embodiment, therefore, the MFP communicates with the mobile terminal by NFC communication, obtains print data from the Web server apparatus by communication via the mobile telephone line or access point, and then connects the mobile terminal to the access point of the MFP via a WLAN. In this way, even if the MFP is not currently connected to the access point of the network, in a case where the user wishes to print the contents on the Web server apparatus, it is possible to obtain print data using the communication functions of the mobile terminal and MFP without directly connecting the MFP and the Web server apparatus.

Furthermore, upon completion of communication processing with the Web server apparatus 101 via the access point, the mobile terminal 200 starts to communicate with the access point unit 308 of the MFP 300. Consequently, upon obtaining print data from the Web server apparatus 101, the mobile terminal 200 need not perform disconnection of the connection to the access point of the MFP 300 or perform reconnection to the access point. It is, therefore, possible to readily perform connection to the access point.

In accordance with NFC communication with the MFP 300, the mobile terminal 200 automatically performs communication with the Web server apparatus 101 and communication with the MFP 300 using a WLAN or the like. Therefore, since the above-described three communication operations are performed when the user moves the mobile terminal 200 close to the MFP 300 for NFC communication, the user can readily print his/her desired image existing in the Web server apparatus 101.

Furthermore, if the user selects a thumbnail on the screen shown in FIG. 6, he/she can print an image corresponding to the thumbnail by moving the mobile terminal 200 close to the MFP 300 to execute NFC communication. Therefore, for example, after selecting a thumbnail, it is possible to execute NFC communication without waiting for the mobile terminal 200 to obtain print data corresponding to the thumbnail.

### Second Embodiment

In the first embodiment, NFC has been exemplified as an example of short distance wireless communication. The present invention, however, is not limited to this, and another communication method may be used. More specifically, Bluetooth® can be used. In this case, a mobile terminal 200 includes a Bluetooth® unit in place of the NFC unit 201, and an MFP 300 includes a Bluetooth® unit in place of the NFC unit 306. The mobile terminal 200 can obtain information of the access point function of the MFP 300 by moving the Bluetooth® unit of the mobile terminal 200 close to that of the MFP 300.

Note that in the second embodiment, both the NFC unit and the Bluetooth® unit may be included instead of including the Bluetooth® unit in place of the NFC unit. In this case, the user can select a unit to be used according to the situation, or one of the mobile terminal 200 and MFP 300 can select a unit to be used.

As an example of communication performed in a case where the mobile terminal 200 receives print data from a Web server apparatus 101, communication via the mobile telephone line and communication via the access point such as WiFi have been exemplified. However, another communication method may be used. Also, as an example of the communication method between the mobile terminal 200 and the MFP 300 after obtaining the print data, a WLAN has been described. However, another communication method may be used. If a communication method whose communicable range is wider than that of NFC is used, it is possible to perform communication even when the mobile terminal 200 is away from the MFP 300. Alternatively, if a communication method whose communication speed is higher than that of NFC is used, it is possible to more efficiently transmit print data. Note that the communication method is not limited to them exemplified here. One method can be used singly or a plurality of methods can be used in combination.

### Third Embodiment

In this embodiment, print data obtaining processing obtained by adding some determination processes to the steps described with reference to FIG. 7 in the first embodiment will be explained.

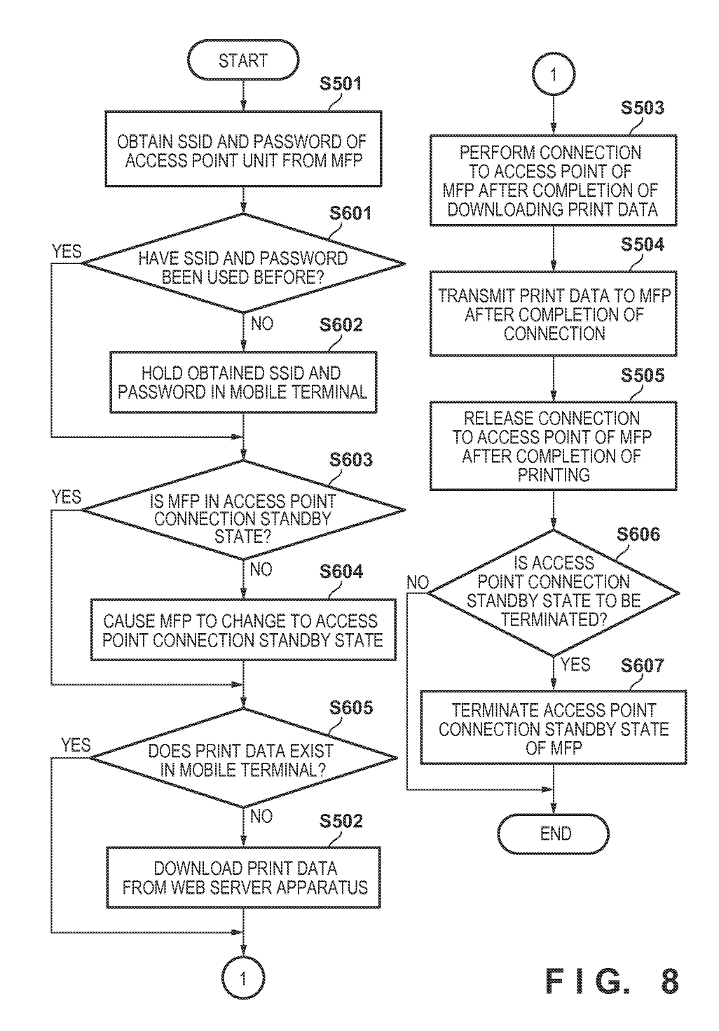

FIG. 8 is a flowchart illustrating print data obtaining processing executed by a mobile terminal according to the third embodiment. As will be apparent by comparing FIGS. 7 and 8, in this embodiment, seven processing steps are added to the processing described in the first embodiment to appropriately obtain print data according to the situation. Note that processes to be added are not limited to those described here. It is possible to add one determination process or a plurality of determination processes in combination.

The seven processing steps to be added are as follows.

(1) Step S601

Based on information about the access point function of an MFP obtained in step S501, it is determined whether the MFP has been used before.

(2) Step S602

If it is determined in step S601 that the MFP has not been used before, the information about the MFP is saved.

(3) Step S603

It is determined whether an access point unit 308 of an MFP 300 already stands by in a connectable state.

(4) Step S604

If it is determined in step S603 that the MFP 300 does not stand by in a connectable state, the mobile terminal causes the MFP 300 to change to a connection standby state.

(5) Step S605

It is determined whether print data received in step S502 has already been obtained by a mobile terminal 200.

(6) Step S606

After releasing connection to the access point unit 308 in step S505, it is determined whether to terminate the connection standby state of the access point unit 308 of the MFP 300.

(7) Step S607

If it is determined in step S606 to terminate the connection standby state, the connection standby state ends.

Details will be described below according to the flowchart shown in FIG. 8. Note that the same description as that in the first embodiment will be omitted for the sake of simplicity.

Similarly to the first embodiment, after executing step S501, the mobile terminal 200 checks in step S601 whether the same information as that of the access point unit 308 of the MFP 300 used before has been recorded. If it is determined that the same information has been recorded, it is determined to use the recorded information and the process advances to step S603. On the other hand, if it is determined that the same information has not been recorded or a password has been changed, the process advances to step S602, and an SSID and password received in step S501 are recorded in the mobile terminal 200.

In step S603, it is checked whether the access point unit 308 of the MFP 300 is already in a connection standby state. Note that the connection standby state indicates a state in which it is possible to perform WLAN connection using the SSID and password held in the mobile terminal 200 but connection or communication has not been established yet.

If it is determined that the access point unit 308 of the MFP 300 is already in the connection standby state, the process skips step S604, and advances to step S605. On the other hand, if it is determined that the access point unit 308 is not in the connection standby state, the process advances to step S604 to execute processing of causing the connection state between the mobile terminal 200 and the access point unit 308 of the MFP 300 to change to a connection standby state.

Note that a case in which the access point unit 308 is not in the connection standby state may be a case in which the access point connection setting of the mobile terminal 200 is OFF, a case in which the mobile terminal 200 is in a connection standby state in another communication mode, or a case in which the mobile terminal 200 is currently connected in another communication mode.

If the access point connection setting is OFF, processing of automatically setting the setting ON is performed in step S604. If the mobile terminal 200 is in a connection standby state in another communication mode or is currently connected in another communication mode, the connection standby state or the connection is interrupted to change to a connection standby state to the MFP 300.

Note that in this embodiment, the mobile terminal 200 executes the processes in steps S603 and S604. However, the MFP 300 may execute these processes. If, for example, the MFP 300 performs NFC communication with the mobile terminal 200 in step S501, the MFP may execute the processing in step S603. Alternatively, the processing in step S604 may be always executed without executing the processing in step S603.

If the MFP 300 executes the processes in steps S603 and S604, it is determined in step S603, for example, whether the access point connection setting of the MFP 300 is OFF. If the access point connection setting is OFF, the MFP 300 performs processing of automatically setting the setting ON in step S604.

If the MFP 300 executes the processing in step S603, for example, it is determined whether the MFP 300 is in a connection standby state in another communication mode or is currently connected in another communication mode. If the MFP 300 is in a connection standby state in another communication mode or is currently connected in another communication mode, the connection standby state or the connection is interrupted to change to a connection standby state to the mobile terminal 200.

In step S605, it is checked whether print data to be received from the Web server apparatus 101 already exists in the mobile terminal 200. If it is determined that the print data exists in the mobile terminal 200, the process skips step S502, and advances to step S503. On the other hand, if it is determined that the print data does not exist in the mobile terminal 200, the process executes step S502.

Note that the processing in step S502 can be executed without executing the processing in step S605. In this case, however, even if desired print data exists in the mobile terminal 200, the same data is downloaded again. Therefore, in terms of improvement of the throughput by preventing data from being redundantly downloaded, it is advantageous to execute step S605.

In steps S503 to S505, the same processes as those described in the first embodiment are executed. Note that in the first embodiment, connection is performed using the SSID and password obtained from the MFP 300 in step S501. On the other hand, in this embodiment, if it is determined in step S601 that the information has already been recorded in the mobile terminal, the recorded SSID and password may be used to perform connection.

In step S606, it is decided whether to terminate the connection standby state of the access point unit 308 of the MFP 300. More specifically, if the access point unit 308 of the MFP 300 is set in the connection standby state in step S604, it is determined to terminate the connection standby state of the access point unit 308 to return to the state before the MFP is used. Alternatively, if it is determined in step S603 that the access point unit 308 of the MFP 300 is already in the connection standby state and the process skips the processing in step S604, it is determined that it is not necessary to terminate the connection standby state of the access point unit 308.

If it is decided to terminate the connection standby state of the access point unit 308 in step S606 based on the above determination result, the process advances to step S607 to terminate the connection standby state of the access point unit 308. On the other hand, if it is decided not to terminate the connection standby state of the access point unit 308, the process simply ends.

Note that the mobile terminal 200 executes the processes in steps S606 and S607 in this embodiment. However, the MFP 300 may execute these processes. Alternatively, the processing in step S607 can be always executed without executing the determination processing in step S606, thereby terminating the connection standby state of the access point unit 308.

According to the above-described embodiment, it is possible to perform more appropriate print data obtaining processing according the situation by executing some determination processes in addition to the processing in the first embodiment, thereby improving the convenience in a case where the user uses the MFP.

In the above-described embodiment, the MFP has been exemplified as an information processing apparatus. The present invention, however, is not limited to the MFP, and is also applicable to a device such as a single function printer, display, projector, or loudspeaker. For example, if a display or projector is adopted as an information processing apparatus, the mobile terminal obtains data to be displayed from the Web server apparatus. If a loudspeaker is adopted as an information processing apparatus, the mobile terminal obtains, from the Web server apparatus, data to be audibly output.

If, for example, the present invention is applied to a display as an information processing apparatus, the mobile terminal obtains the SSID and password of the access point unit of the display using the NFC unit of the display. Then, the mobile terminal obtains the contents to be displayed on the display from the Web server apparatus. After completion of the obtaining processing, the mobile terminal and the display are connected using a WLAN. After that, the mobile terminal transmits, to the display, the contents to be displayed on the display.

If the present invention is applied to a loudspeaker, the mobile terminal obtains the SSID and password of the access point unit of the loudspeaker using the NFC unit of the loudspeaker. Then, the mobile terminal obtains music data to be played back by the loudspeaker from the Web server apparatus. After completion of the obtaining processing, the mobile terminal and the loudspeaker are connected using a WLAN. After that, the mobile terminal transmits, to the loudspeaker, the music data to be played back by the loudspeaker. As described above, even if the present invention is applied to another device, the methods described in the first to third embodiments are applicable.

Note that the “print data” described in the above embodiments may be, for example, an image file to be printed, a file of vector data such as graphic data, or a document file. Various file formats such as Jpeg, PDF, Ping, Gif, document file, and spreadsheet file are possible. If, for example, data of various data formats are stored in the Web server apparatus 101, the Web server apparatus 101 or another server apparatus may convert the data into a predetermined data format. Then, the converted data may be transmitted to the mobile terminal 200. The predetermined data format may be, for example, a bitmap image or PDF file.

In the above embodiments, the Web server apparatus has been exemplified as an external apparatus from which the mobile terminal 200 obtains data. The present invention, however, is not limited to this. For example, the mobile terminal 200 may obtain data from an external apparatus such as another mobile terminal or external PC.

In the above embodiments, a case in which the access point unit 308 of the MFP 300 operates in the access point (AP) mode and WLAN connection is established in one-to-one correspondence with the mobile terminal 200 has been explained. The present invention, however, is not limited to this. The MFP 300 and the mobile terminal 200 may be connected in an ad hoc mode in one-to-one correspondence with each other. In this case as well, after the mobile terminal 200 obtains data from the Web server apparatus or an external apparatus such as another mobile terminal or external PC, it establishes connection to the MFP 300. This can avoid a case in which the mobile terminal 200 cannot obtain data from an external apparatus since it has established connection in one-to-one correspondence with the MFP 300.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-080496, filed Apr. 9, 2014, which is hereby incorporated by reference herein in its entirety.

What is claimed is:

1. A communication method for a communication terminal which communicates with an information processing apparatus, comprising:
obtaining, by using a first communication method by short distance wireless communication, from the information processing apparatus, connection information for communication with the information processing apparatus by a second communication method;
obtaining data existing in an external apparatus via a network;
establishing communication with the information processing apparatus by the second communication method by using the obtained connection information after the data is obtained; and
transmitting the obtained data to the information processing apparatus by the established communication.

2. The method according to claim 1, wherein the data is obtained after the connection information is obtained.

3. The method according to claim 1, further comprising releasing the established communication.

4. The method according to claim 1, wherein the first communication method of the short distance wireless communication includes at least one of NFC and Bluetooth®.

5. The method according to claim 1, wherein a communicable range of the second communication method is wider than that of the first communication method by the short distance wireless communication.

6. The method according to claim 1, further comprising:
holding the obtained connection information; and
determining whether the obtained connection information is the same as the held connection information obtained before,
wherein if it is determined in the determining that the pieces of the information are the same, the held connection information is used to establish the communication.

7. The method according to claim 1, further comprising:
determining whether a connection state of an access point of the information processing apparatus is a connection standby state; and
causing, if it is determined in the determining that the access point is not in the connection standby state, the connection state of the access point to change to the connection standby state.

8. The method according to claim 1, wherein in the establishing, upon newly accessing the external apparatus and newly obtaining the data, communication with the information processing apparatus by the second communication method is established.

9. The method according to claim 1, further comprising:
determining, before obtaining the data, whether the data has already existed in the communication terminal; and
controlling, if it is determined that the data has already existed in the communication terminal, to skip obtaining the data.

10. The method according to claim 3, further comprising deciding, after execution of the releasing, whether to terminate the connection standby state of the access point of the information processing apparatus, based on a result of determining whether the connection state of the access point of the information processing apparatus is the connection standby state.

11. The method according to claim 1, wherein the external apparatus is a Web server apparatus.

12. A communication terminal for communicating with an information processing apparatus, comprising:
a communication unit configured to obtain, by using a first communication method by short distance wireless communication, from the information processing apparatus, connection information for communication with the information processing apparatus by a second communication method;
an obtaining unit configured to obtain data existing in an external apparatus via a network;
an establishment unit configured to establish communication with the information processing apparatus by the second communication method by using the connection information obtained by said communication unit after said obtaining unit obtains the data; and
a transmission unit configured to transmit the data obtained by said obtaining unit to the information processing apparatus by the communication established by said establishment unit.

13. The terminal according to claim 12, wherein the information processing apparatus includes an MFP, a display, and a loudspeaker.

14. The terminal according to claim 13, wherein if the information processing apparatus is an MFP, the data obtained by said obtaining unit from the external apparatus is print data.

15. The terminal according to claim 12, wherein the data is obtained after the connection information is obtained.

16. The terminal according to claim 12, further comprising a release unit configured to release the established communication.

17. The terminal according to claim 12, wherein the first communication method of the short distance wireless communication includes at least one of NFC and Bluetooth®.

18. The terminal according to claim 12, wherein a communicable range of the second communication method is wider than that of the first communication method by the short distance wireless communication.

19. The terminal according to claim 12, wherein the external apparatus is a Web server apparatus.

20. A non-transitory computer readable storage medium which stores a computer program to be executed in a communication terminal, the program comprising:
obtaining, by using a first communication method by short distance wireless communication, from an information processing apparatus, connection information for communication with the information processing apparatus by a second communication method;
obtaining data existing in an external apparatus via a network;
establishing communication with the information processing apparatus by the second communication method using the obtained connection information after the data is obtained; and
transmitting the obtained data to the information processing apparatus by the established communication.
